(19) United States
(12) Patent Application Publication
(10) Pub. No.: US 2014/0153228 A1
(43) Pub. Date: Jun. 5, 2014

(54) Illuminating module

(71) Applicant: NINGBO XIESHENG LIGHTING INDUSTRIAL CO., Ninghai (CN)

(72) Inventor: Yongqiang HONG, Ninghai (CN)

(73) Assignee: NINGBO XIESHENG LIGHTING INDUSTRIAL CO., LTD, Ninghai (CN)

(21) Appl. No.: 13/691,863

(22) Filed: Dec. 3, 2012

(51) Int. Cl. F21V 14/02

(52) U.S. Cl. CPC F21V 14/025
USPC 362/188

(57) ABSTRACT

The present patent application is directed to a illuminating module. The illuminating module includes an LED and composite optical lens. The composite optical lens includes a condenser lens and a reflection mirror that forms from extension by two sides of the condenser lens. The condenser lens includes a convex base surface and a convex launch-out surface that corresponds to a base surface. A blind hole is formed between the convex base surface and the reflection mirror. The LED is capable of moving along a lens optical axial direction of the composite optical lens within the blind hole.

### TECHNICAL FIELD

The present patent application is directed to an illuminating module, specifically to a light emitting diode (LED) illuminating module.

### BACKGROUND

Conventional incandescent flashlight includes a cone-shaped lamp head that tapers toward an end point. The interior is situated with a parabolic concave reflecting mirror. On the focus point of the concave reflecting mirror is situated with incandescent lamp or its spiral shaped filament. This kind of concave reflecting mirror can easily become contaminated or fade due to the effect of corrosion, rendering reflection of light becoming relatively weak.

Subsequently, LED flashlights are introduced into the market. This kind of flashlight consumes less electricity relative to the incandescent lamp and can function at relatively low working voltage under most of the conditions. Hence, a small-sized battery is sufficient as a power source. It is especially applied with LED which can produce flashlight by methods that lead to its relatively small in structure, and can allow it to become, for example, a key chain accessory that is convenient to carry with. Besides its relatively low power consumption, the LED cannot be easily sensitive to external force, rendering it to have prolonged life.

For some existing well known flashlights, a condenser lens is situated on the surface where light is emitted out. Under the condition that allows the location of the light emission to be situated on the focus point of the condenser lens, generally paralleled beam can be emitted. However, if the LED causes part of the light to face sideway, i.e., emitting at an angle relatively higher than the corresponding axis, these light will not be able to be reflected.

Therefore, a new composite optical lens is necessary. By taking the advantages of the optimal characteristics of the LED and the lens, allowing all light emitted by the LED to be able to be fully utilized by reflection/defraction through the lens, an energy-saving environment can be realized.

### SUMMARY

The purpose of the present patent application is to provide a new illuminating module that is relatively small in size and convenient to carry.

The illuminating module includes an LED and composite optical lens. The composite optical lens includes a condenser lens and a reflection mirror that forms from extension by two sides of the condenser lens. The condenser lens includes a convex base surface and a convex launch-out surface that corresponds to a base surface. A blind hole is formed between the convex base surface and the reflection mirror. The LED is capable of moving along a lens optical axial direction of the composite optical lens within the blind hole.

Through the movement of the LED along the optical axial direction of the composite optical lens corresponding to the blind hole, different irradiation characteristics of the different light beam of the cone angle can be variably adjusted.

### DRAWINGS

FIG. 1 is a perspective view of a composite optical lens.

FIG. 2 is a view of a first kind of illuminating light beam.

FIG. 3 is a view of a second kind of illuminating light beam.

FIG. 4 is a view of a third kind of illuminating light beam.

### DETAILED DESCRIPTION

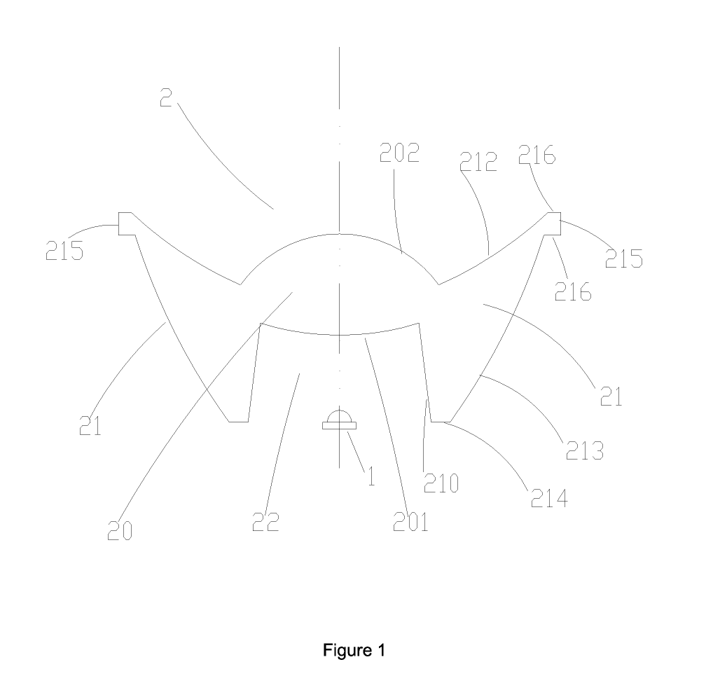

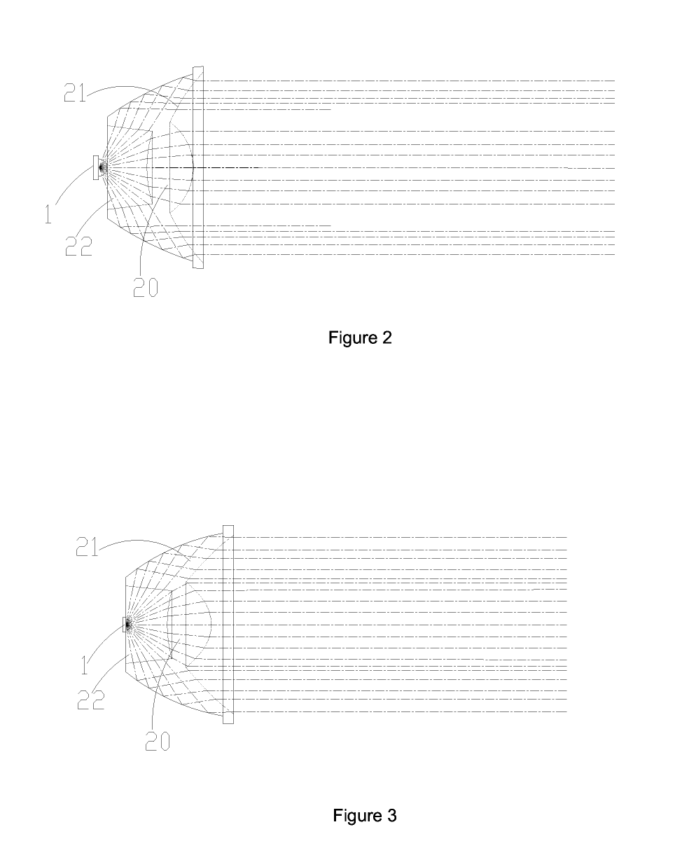

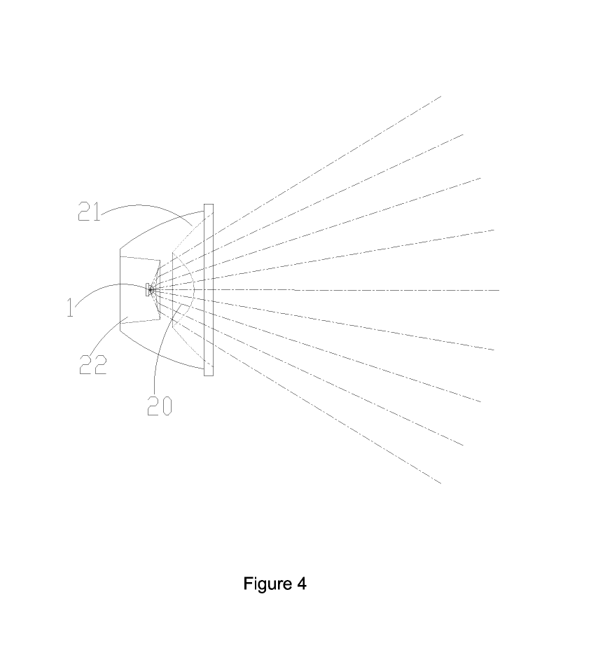

As illustrated in FIG. 1 to FIG. 4, the present patent application is directed to an illuminating module, including an LED 1 and a composite optical lens 2. The composite optical lens is symmetric about an optical axis. The composite optical lens 2 includes a condenser lens 20 and a reflection mirror 21 formed by extension from two sides of the condenser lens 20. The condenser lens 20 includes a convex base surface 201 and convex emitting surface 202 that corresponds with the convex base surface. Between the convex base surface 201 and the reflection mirror 21, a blind hole 22 is formed. The LED 1 can axially move along the optical axis of the composite optical lens within the blind hole 22. Through the movement of the LED along the optical axis corresponding to the blind hole, different irradiation characteristics of different cone angles of the light beam can be variably adjusted.

The reflection mirror 21 includes at least one light launch-in surface 210 and one light launch-out surface 212 that has a conical circumference with an arc shaped cross-section. Between the light launch-in surface 210 and light launch-out surface 212, a light reflecting surface 213 is formed.

The light launch-in surface 210 and the light reflecting surface 213 are connected through the horizontal surface 214 that is perpendicular to the lens optical axis. The light reflecting surface 213 and the light launch-out surface 212 are connected through a vertical surface 215 that is parallel to the optical axis of the lens.

The light launch-out surface 212 and the light reflecting surface 213 extend horizontally and form horizontal surfaces 216, 216 that are perpendicular to the lens optical axis, respectively. The horizontal surfaces 216, 216 are connected to the vertical surface 215.

The difference in the diameter of the condenser lens 20 and the diameter of the blind hole 22 is less than or equal to 2 mm. The diameter of the blind hole 22 is greater than or equal to 10 mm. Therefore, it allows the LED including a lamp holder to move along the axial direction within the blind hole 22, rendering the LED together with the lamp holder to be able to be pushed into the blind hole 22.

The ratio of the height to diameter of the composite optical lens is 0.5˜0.6, preferably between 0.54˜0.58. The total height of the composite optical lens is between 16.2 mm and 25 mm.

The ratio of the thickness of the condenser lens to the height of the composite optical lens is 0.2˜0.5, preferably between 0.24 and 0.41.

The ratio of the diameter of the condenser lens to the diameter of composite optical lens is 0.35˜0.45.

The curvature radius of the convex base surface of the condenser lens is less than the curvature radius of the convex launch-out surface. Composite optical lens is constructed by plastics selected preferably from PMMA or glass.

The blind hole 22 has a circumference diameter that allows the LED 1 to axially move along the optical axis of the composite optical lens within the blind hole 22. All the light launch-in and launch-out surfaces allow the slanted light to be refracted this way. Light launched-out by LED basically can completely, especially more than 85%, move along the axial direction, producing changes in conical angle of light at less than or equal to 12° up to conical angle at more than or equal to 30°. On at least one LED location of the blind hole that corresponds to the composite optical lens, the cross-section lying vertical to the optical axis evenly illuminate an interior light cone region. Preferably at 2.5 meters distance and evenly illuminate a circle that has a diameter of 0.6 meters. The surface of refracted light or completely reflected light can use the two-dimensional size cutting method to perform calculations.

In a preferred solution, the composite optical lens is situated at a lamp head that move along the axial direction which corresponds to a lamp. The LED is also securely installed inside the lamp When necessary, a guiding device along the axial direction or a spiral direction can be situated. For example, the total diameter of the composite optical lens can be 29 mm, 35 mm, 40 mm or 46 mm, which correspond to the structural height of 16.2 mm, 20 mm, 22 mm or 25 mm, respectively.

1. A illuminating module, comprising an LED and a composite optical lens, wherein the composite optical lens comprises a condenser lens and a reflection mirror that forms from extension by two sides of the condenser lens, the condenser lens comprises a convex base surface and a convex launch-out surface that corresponds to the convex base surface, a cross section of the convex base surface is a convex curve curving outward, a blind hole is formed between the convex base surface and the reflection minor, and the LED is capable of moving along a lens optical axial direction of the composite optical lens within the blind hole.

2. The illuminating module according to claim 1, wherein the reflection mirror comprises at least one light launch-in surface and a light launch-out surface.

3. The illuminating module according to claim 2, wherein a light reflection surface is formed between the light launch-in surface and the light launch-out surface.

4. The illuminating module according to claim 3, wherein the light launch-in surface and the light reflection surface are connected through a horizontal surface that is perpendicular to the lens optical axis, and the light reflection surface and the light launch-out surface are connected through a vertical surface that is parallel to the lens optical axis.

5. The illuminating module according to claim 4, wherein the light launch-out surface and the light reflection surface extend horizontally and form horizontal surfaces that are perpendicular to the lens optical axis, respectively, and the horizontal surfaces are connected through a vertical surface.

6. The illuminating module according to claim 1, wherein the difference between the diameter of the condenser lens and the diameter of the blind hole is less than or equal to 2 mm, and the diameter of the blind hole is greater than or equal to 10 mm.

7. The illuminating module according to claim 1, wherein the ratio of the height of the composite optical lens to the diameter of the composite optical lens is 0.5˜0.6, and the total height of the composite optical lens is between 16.2 mm and 25 mm.

8. The illuminating module according to claim 1, wherein the ratio of the thickness of the condenser lens to the height of the composite optical lens is 0.2˜0.5.

9. The illuminating module according to claim 1, wherein the ratio of the diameter of the condenser lens to the diameter of the composite optical lens is 0.35˜0.45.

10. The illuminating module according to claim 1, wherein the curvature radius of the condenser lens convex base surface is less than the curvature radius of the convex launch-out surface.
